(19) United States
(12) Patent Application Publication
(10) Pub. No.: US 2007/0095819 A1
(43) Pub. Date: May 3, 2007

(54) CONTROLLER TO PROVIDE A UNIFORM TEMPERATURE FOR ELECTRIC FRYING PANS

(75) Inventors: William G. Kuban, Minneapolis, MN (US); Steven J. Rathjen, South Lake Tahoe, CA (US)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Kurt Manufacturing, Inc., Minneapolis, MN (US)

(21) Appl. No.: 11/556,483

(22) Filed: Nov. 3, 2006

Related U.S. Application Data
(60) Provisional application No. 60/733,028, filed on Nov. 3, 2005.

(51) Int. Cl. H05B 1/02

(52) U.S. Cl. 219/512

(57) ABSTRACT

A controller provides adjustable power levels to heat a cooking device. A power flow controller can be used to adjust levels of power received from a power source.

### CROSS-REFERENCE TO RELATED APPLICATION

The present application is based on and claims the benefit of U.S. provisional patent application Ser. No. 60/733,028, filed Nov. 3, 2005, the content of which is hereby incorporated by reference in its entirety.

### BACKGROUND

Current electric frying pans do not easily or satisfactorily allow one to slow cook food, such as meat, without having the heating element of the electric frying pan getting overly hot. A typical thermostat control of a frying pan merely switches the heating element from full on to off, with the control being an average temperature. For example, if one wants to cook meat in the electric frying pan, the user will typically sear the meat first. After searing the meat in the pan, if one wants to slow cook, the user adjusts the temperature of the electric frying pan to a lower temperature such as 200° F. However, in order to maintain the average temperature of 200° F., the heating element in the bottom of the electric frying pan will be turned fully on, thereby obtaining an extremely hot temperature until the overall temperature comes to 200° F. Nevertheless, the extremely hot temperatures will cause some burning off of the meat juices, gravy and similar liquids during the time when the heater is on.

### SUMMARY

A controller provides adjustable power levels to heat a cooking device. By providing adjustable power levels, the controller can maintain a temperature of the cooking device close to a desired temperature set by a user.

### BRIEF DESCRIPTION OF THE DRAWINGS

FIG. 1 is a schematic view of an environment for controlling temperature of an electric frying pan.

FIG. 2 is a schematic view of an environment for controlling temperature of an electric frying pan.

FIG. 3 is a flow diagram of operation of a controller for controlling temperature of an electric frying pan.

### DETAILED DESCRIPTION

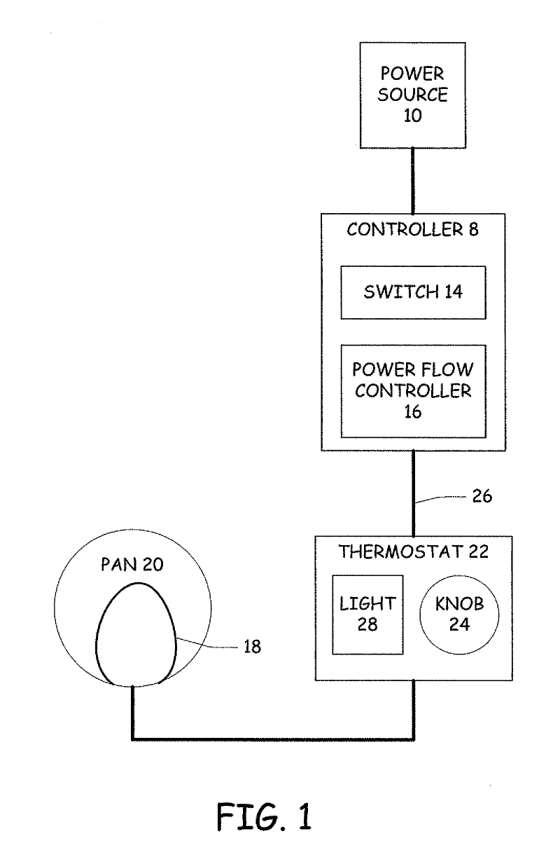

FIG. 1 illustrates a controller 8 that provides uniform temperatures for electric frying pans for purpose of slow cooking. In particular, the temperature of the frying pan can be selected. In the embodiment illustrated, the controller 8 can comprise a power flow controller such as an AC speed controller, for example, used for AC power tools such as drills and routers. The controller 8 is connectable to a source of AC power such as 110 volts, which is represented at source 10. The controller 8 includes a selection switch 14, which can be set to a “constant” output setting, namely 110 volts output, or a “variable” output setting, which would allow power to flow through a power flow controller 16. Any suitable device can be used to control the power, for example a rheostat, variable voltage transformer or triac circuit such as used in speed control of drills and routers. The power flow controller 16 controls the power to a heating element 18 of a frying pan 20. With the adjustable (i.e., lower) voltage provided to the heating element 18, the heating element can maintain a uniform temperature that is lower than the high temperature that would be obtained if it were otherwise connected directly to 110 volts AC.

In the embodiment illustrated, frying pan 20 can be of a conventional design having a temperature controller shown as thermostat 22, with an adjustable knob 24 correlated to desired temperatures. A light 28 typically is provided to indicate when power is being provided to the heating element 18. A power cord 26 of the electric frying pan 20 is connected to the controller 8 typically via a female electrical receptacle. When a temperature of frying pan 20 is less than the temperature indicated by knob 24, power is supplied to heating element 18. If the temperature of frying pan 20 is above the temperature indicated by thermostat 22, power is not drawn by heating element 18. It should be noted that controller 8 could be integrated into a single element with thermostat 22, if desired.

Use of controller 8 with electrical frying pan 20 to cook meat can be as follows. Initially, switch 14 is adjusted to the “constant” setting so that full 110 volts is provided to heating element 18 of the electric frying pan 20. Using the temperature adjustment capabilities of the electric frying pan 20, one can set thermostat 22, for example, at 400° F. to brown or sear the meat. Then, in order to provide slow cooking of the meat, the knob 24 is adjusted to a lower setting, such as 200° F., at the controller 22 and the pan is allowed to cool down to 200° F. Using the knob 24, it can be determined in conjunction with the light 28 coming on as to operation of the heating element 18 with regard to the desired temperature of the electric frying pan 20. When the lowered desired temperature has been obtained, the knob 24 is maintained at the desired, temperature and the switch 14 is operated to the “variable” setting. Power flow controller 16 is then adjusted so as to cause light 28 to flicker, which indicates that the heating element is receiving enough power at a reduced voltage in accordance with the controller 8, but sufficient to maintain the electric frying pan 20 at the desired temperature

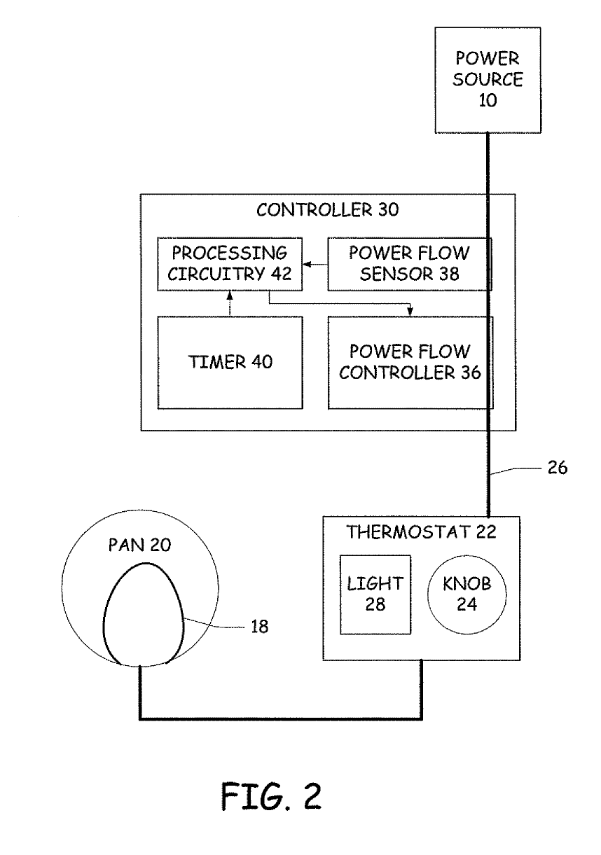

FIG. 2 illustrates another embodiment of a controller 30, similar in purpose to controller 8 described above. Like controller 8, controller 30 includes a connector 26 suitable for obtaining power from the electrical source 10 and an output receptacle through which heating element 18 of electric frying pan 20 can be connected. Controller 30 allows for automatic adjustment of electrical power provided to the electric frying pan 20 in order to maintain the desired temperature. Thus, the need for a user controlled power flow controller described with respect to FIG. 1 is obviated.

Controller 30 includes a power flow controller 36 (such as a triac), a power flow sensor 38 (such as a current or voltage sensor) and a timer 40. Processing circuitry 42 controls operation of the power flow controller 36. Processing circuitry 42 can include a counter coupled to a decoder to select a particular relay or a combination of relays. Each relay can include a resistor to provide a desired control signal to power flow controller 36. As in the previous embodiment, the user adjusts knob 24 to obtain a desired temperature. Additionally, it should be noted that controller 30 can be formed as a single unit with thermostat 22.

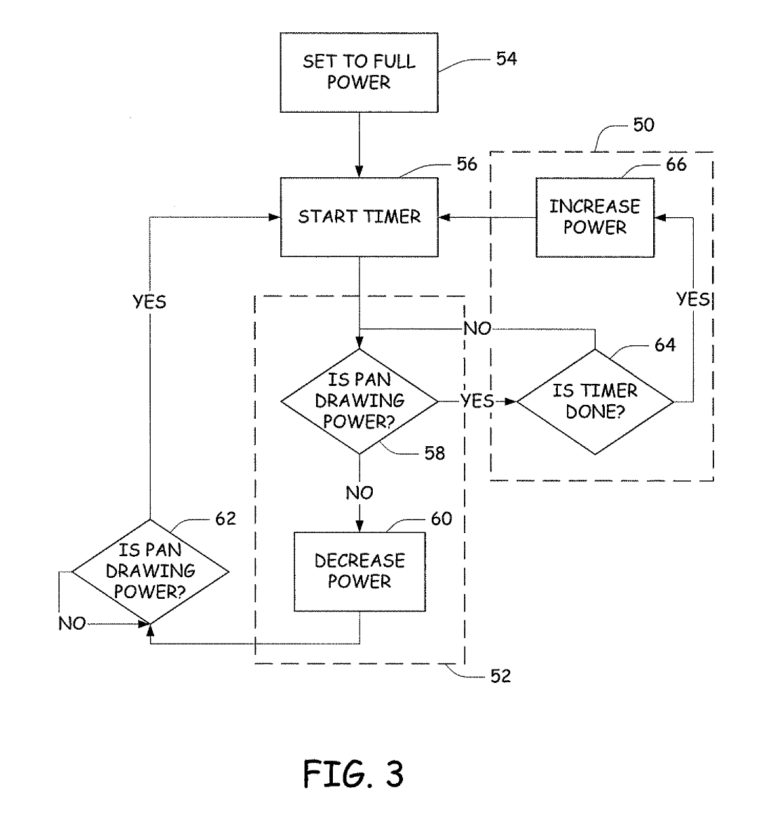

FIG. 3 is a flow diagram of operation of controller 30. Generally, the flow diagram illustrates a controlled loop 50 for increasing power (i.e. voltage) to the frying pan and a second control loop 52 for decreasing the power to the electric frying pan. The sensor 38 and timer 40 are used to control operation between the control loops 50 and 52 in order to automatically obtain the necessary power to maintain the desired temperature of the pan 20.

Assuming initially a starting point of providing full power is capability to the electric frying pan, as indicated at step 54, controller 30 then initiates the timer at step 56. At step 58, it is determined whether or not the electric frying pan is drawing any power as measured by the sensor 38 at step 58. If the electric frying pan is not drawing any power it is apparent that full power is not needed in order to maintain a desired temperature and the temperature is reduced at step 60. The power can be reduced by a suitable interval, for example by 5 or 10 percent. This new power setting is maintained until the electric frying pan actually draws power as indicated at step 62 where upon flow returns back to step 56 and the timer is again started.

Assuming now that the electric frying pan is drawing power at step 58, flow continues to step 64 where upon the timer is checked to see if it has timed out. If the timer has not timed out, flow continues back to step 58 in order to determine if this electric frying pan is still drawing power. This loop is continued until the timer has timed out indicating that the electric frying pan requires more power in order to obtain a desired temperature. Accordingly, flow continues to step 66 where the power is increased and the timer is again restarted at step 56. By using control loops 50 and 52, the necessary power to obtain the desired temperature can be ascertained within a range.

Although the concepts provided herein have been described with reference to preferred embodiments, workers skilled in the art will recognize that changes may be made in form and detail without departing from the spirit and scope of the claimed subject matter.

What is claimed is:

1. An electric cooking device, comprising:
a frying pan;
a heating element coupled to the pan;
a thermostat adjustable to a temperature setting; and
a controller adapted to provide a level of voltage to the heating element from a power source as a function of the temperature setting of the thermostat.

2. The electric cooking device of claim 1 wherein the controller includes a voltage adjuster.

3. The electric cooking device of claim 2 wherein the voltage adjuster includes one of a rheostat and a variable voltage transformer.

4. The electric cooking device of claim 2 wherein the controller includes a switch to selectively provide power to the voltage adjuster.

5. The cooking device of claim 1 wherein the controller includes a power flow controller configured to adjust a level of power provided to the heating element.

6. The cooking device of claim 5 wherein the power flow controller includes a triac.

7. The cooking device of claim 1 wherein the controller includes a current sensor to sense current flowing to the heating element.

8. The cooking device of claim 5 wherein the controller further includes a timer coupled to the power controller to determine if a level of voltage should be adjusted.

9. A method of heating food in an electric frying pan, comprising:
providing a heating element for the electric frying pan; and
providing a power flow controller connected to the heating element of the frying pan.

10. The method of claim 9 and further comprising:
providing a thermostat to indicate a desired temperature.

11. The method of claim 10 and further comprising:
adjusting power flow to the heating element using the power flow controller as a function of the desired temperature.

12. The method of claim 11 and further comprising:
determining if the desired temperature of the frying pan has been reached.

13. The method of claim 9 and further comprising:
providing power to the heating element from a power source.

14. The method of claim 13 and further comprising:
determining if the heating element is drawing power from the power source.

15. The method of claim 14 and further comprising:
decreasing power provided to the heating element using the power flow controller if the heating element is not drawing power from the power source.

16. The method of claim 14 and further comprising:
initiating a timer for a specified time period; and
increasing power provided to the heating element using the power flow controller if the heating element is drawing power from the power source after the time period.

17. The method of claim 9 wherein the power flow controller includes a triac.
